(19) United States
(12) Patent Application Publication
(10) Pub. No.: US 2025/0353624 A1
(43) Pub. Date: Nov. 20, 2025

(54) ARMORED DEPLOYMENT SYSTEM FOR LAUNCHING DRONES

(71) Applicant: XTG, LLC, Tulsa, OK (US)

(72) Inventors: Ryan Keith, Tulsa, OK (US); Daniel Cramer, Tulsa, OK (US)

(21) Appl. No.: 19/212,399

(22) Filed: May 19, 2025

Related U.S. Application Data
(60) Provisional application No. 63/648,713, filed on May 17, 2024.
(60) Provisional application No. 63/664,228, filed on Jun. 26, 2024.
(60) Provisional application No. 63/674,352, filed on Jul. 23, 2024.

(51) Int. Cl. B64U 70/93

(52) U.S. Cl. CPC B64U 70/93

(57) ABSTRACT

A drone deployment system of this disclosure includes an enclosed cargo bay or space including at least one wall having at least one section moveable between a closed position and an opened position; and a launch platform adapted for use with one or more drones, the launch platform housed by the enclosed cargo bay and located opposite the at least one section, the launch platform moveable between a stowed and a deployed elevation, angular orientation, or elevation and angular orientation. The enclosed cargo bay may be armored. When in the opened position, the opening provides a space through which the one or more drones may be launched. In some embodiments, the at least one section is slidable. In other embodiments, the section is pivotable. Embodiments of this disclosure provide for transport, launch and recovery of drones from remote areas as well as service and charging of drones in remote areas.

### CROSS-REFERENCE TO CO-PENDING PATENT APPLICATIONS

This application claims priority to, and the benefit of U.S. 63/648,713 filed May 17, 2024; U.S. 63/664,228 filed Jun. 26, 2024; and U.S. 63/674,352 filed Jul. 23, 2024, the priority US applications titled Armored Van or Truck with Pivoting Roof Sections, the content of each incorporated herein by reference.

### BACKGROUND

This disclosure is in the field of platforms used to launch unmanned aerial vehicles or drones and, in particular, motorized vehicles and trailers used as a launching platform.

### SUMMARY

Embodiments of a drone deployment system of this disclosure comprise an enclosed cargo bay including at least one wall having a hinge and a pivotable wall section, the pivotable wall section being connected to the hinge; at least one cylinder including a rod end connected to the pivotable wall section, the at least one cylinder chosen from a hydraulic, pneumatic, or electric cylinder; and a launching platform housed within the enclosed cargo bay. The pivotable wall section may pivot or rotate about an axis that extends in a longitudinal (horizontal) direction of the enclosed cargo bay. In other embodiments, the pivot or rotation may be about an axis that extends in the vertical direction of the enclosed cargo bay. The launch platform may include one or more launch tables.

When the pivotable wall section is in a fully opened position, one or more drones resting on the launch platform may be launched. The launch platform, which may comprise one or more launch tables, may be adjustable in height or in angle (or both) and may be extendable in a horizontal direction. An operator control room may be connected to the enclosed cargo bay and used to control the at least one cylinder, the launch platform, and the launching of drones. The operator control room may include graphical displays in addition to controls in communication with the at least one cylinder, the launch platform, and the one or more drones.

The at least one wall may be a side wall, the pivoting wall section being all or a portion of the side wall. The pivotable wall section may further include all or a portion of a top wall adjacent to the side wall. In some embodiments, at least one three-bar hinge is connected to the side wall and the portion of the top wall.

The at least one cylinder may be mounted in a vertical or horizontal orientation. In some embodiments, pairs of cylinders are used, with each cylinder located at or toward a corresponding end of the pivotable wall section. In some embodiments, the rod end of the cylinder may be connected to a curved arm or bracket. The cylinder may be oriented at an oblique angle to the side wall.

In some embodiments of this disclosure, the enclosed cargo bay is a main bay of an armored vehicle and includes a roof having a pair of first and second roof sections, each roof section pivoting about a hinge, between a closed position and an open position. When one or both of the roof sections are in the open position, one or more drones housed in the main bay may be launched from the vehicle.

The armored vehicle may be a van or truck. The size of the vehicle is predetermined, in part, based upon the size, type, and quantity of drones to be housed within a main bay of the vehicle. The length of the vehicle may be in a range of 20′ to 40′.

In embodiments, the enclosed cargo bay, as well as the cab of the armored vehicle, may include a level 3 or grade 3 (military standard) outer shell and spall liners made with Kevlar® fiber or its equivalent, mounted to the inside of the shell. In other embodiments, only a portion of the enclosed cargo bay is armored. In yet other embodiments, the enclosed cargo bay, as well as the cab of the vehicle, may have a standard (non-armored) shell.

The enclosed cargo bay may be in a range of about 20 feet to about 53 feet in length (˜6 m to ˜16 m) or greater, about 8 feet to about 17 feet wide (˜2.64 m to ˜5.2 m), and have an interior height of about 9 feet (˜2.7 m). Two or more enclosed cargo bays may be connected end-to-end. Or, two enclosed cargo bays may be connected side-to-side to accommodate larger drones.

In some embodiments, the enclosed bay may be mounted on an axled trailer rather than a van or truck chassis. The trailer may be a multi-axle trailer frame. In some embodiments, the trailer is a flatbed trailer. In other embodiments, the trailer is a step deck trailer. The trailer length may be in a range of about 20 feet to about 53 feet (or more) (˜6 m to ˜16 m) or greater.

The enclosed cargo bay may be configured as a shipping container and mountable on a trailer or rail car. By way of a non-limiting example, the container may be a 40-foot or 53-foot (˜12 m to ˜16 m) ocean container. In some embodiments, the roof of the shipping container may slide or pivot open. The shipping container may be equipped with a manual hoist, an electric hoist, or a pallet jack for raising the launch platform. Other embodiments of this disclosure may be similarly equipped.

In embodiments of a drone deployment system of this disclosure, the system comprises an enclosed cargo bay including at least one wall having at least one section moveable between a closed position and an opened position; and a launch platform adapted for use with one or more drones, the launch platform housed by the enclosed cargo bay and located opposite the at least one section, the launch platform moveable between a first (stowed) and a second (deployed) elevation, angular orientation, or elevation and angular orientation. The enclosed cargo bay may be an armored enclosed cargo bay and can be adapted for connection to a vehicle chassis or a trailer.

The at least one section may be slidable between the closed and opened positions or pivotable between the closed and opened positions. Sliding of the section may be in a longitudinal direction of the enclosed cargo bay. Pivoting of the section may be about an axis of rotation extending in the longitudinal direction of the enclosed cargo bay. The section may be all or a portion of the top wall, a side wall, or a combination of portions of the top and side walls. In embodiments, the front and rear walls may include doors or passageways for ingress and egress to the enclosed cargo bay.

Where the at least one section is pivotable, the at least one wall may include a hinge with the at least one section connected to the hinge. In embodiments, the hinge is a longitudinally extending hinge along a side wall of the enclosed cargo bay. At least one cylinder including a rod end is connected to the at least one section. The at least one cylinder may be a hydraulic, pneumatic, or electric cylinder. The cylinder may be arranged in any orientation effective, including horizontal, vertical, or oblique.

In some embodiments, the at least one section further includes a portion of another wall arranged orthogonal to the at least one wall. The at least one wall can be a side wall and the another wall can be a top wall. A three-bar hinge may be connected to the side wall and the top wall.

In other embodiments, the drone deployment system includes a curved arm or bracket having one end connected to the rod end of the at least one cylinder and another end connected to the at least one section.

The launch platform may comprise one or more launch tables. The platform or tables may include cradles or pads for the drones. In some embodiments, the launch platform is extendable in a horizontal direction. The launch platform may have a stowed position and a deployed position, the two positions differing from one another in elevation or angular orientation or both elevation and angular orientation.

An operator control room may be connected to the enclosed cargo bay and include controls in communication with the at least one section, the launch platform, and the drones to be launched. In some embodiments, the control room includes a passageway for ingress to and egress from the enclosed cargo bay.

Embodiments of this disclosure provide for transport, launch and recovery of drones from remote areas as well as service and charging of drones in remote areas. Redundancy to ensure reliability may include a back-up air compressor, an auxiliary air tank, multiple valves to mitigate leaks caused by damage, and multiple pneumatic cylinders. Vehicles of this disclosure may include a pass through from cab of the vehicle to the operator station or control room adjacent the drone launching bay.

### BRIEF DESCRIPTION OF THE DRAWINGS

FIG. 1 is side elevation view of an embodiment of an armored van or truck of this disclosure.

FIG. 2 is a top plan view of the armored van or truck of FIG. 1, a portion of the roof being cutaway to show a plurality of spaced-apart cylinders connected to one of the pivoting roof sections and a portion of the ribbing or bracing used to strengthen the section.

FIG. 3 is an end view of the armored van or truck of FIG. 1 showing its pivoting roof sections as the sections deploy between a closed and open position. In embodiments, a 3-bar hinge limits the travel of the roof section and, therefore, prevents damage to the cylinder rod. See FIG. 6.

FIG. 4 is a side elevation view of an embodiment of an armored van or truck of this disclosure showing cylinder rod connecting points along the hinge.

FIG. 5 is a top plan view of an armored van or truck of FIG. 4 showing the bracing underlying the roof sections, as well as the connection points at the piston end of the cylinders.

FIG. 6 is a schematic view showing the cylinder and a corresponding 3-bar hinge.

FIG. 7 is an example of a shorter length armored vehicle that may be modified in accordance with this disclosure.

FIG. 8 is a model of an embodiment of the main bay or shell of an armored vehicle of this disclosure, the sidewalls and roof shown as clear panels to show the underlying hinge and cylinder mechanism.

FIG. 9 is another model illustrating the relationship between the shell of FIG. 8 and the axles and cab of the armored vehicle.

FIG. 10 is a side elevation view of FIG. 9, again illustrating the relationship between the shell, axles, and cab.

FIG. 11 is a top plan view of the shell of FIG. 8.

FIG. 12 is an enlarged side view of a joint end of one roof section overlapping the joint end of another roof section. In embodiments, the joint end includes a seal.

FIG. 13 is an enlarged view of a cylinder, rod, and arcuate or curved bracket of FIG. 8, the rod and bracket limiting overall travel of the roof section. The rod does not extend or retract in a plane parallel to the sidewall but rather angles away from the sidewall. As the rod extends, the curved bracket “turns the corner,” clearing the sidewall hinge and permitting the roof section to pivot into its fully open position.

FIG. 14 is an isometric view of an embodiment in which the armored vehicle is mounted on a trailer rather than a vehicle chassis.

FIG. 15 is an isometric view of the armored vehicle of FIG. 15 illustrating the sidewall framing and cylinder arrangement.

FIG. 16 is another isometric view of the armored vehicle of FIG. 16 and illustrating portions of the operator's cab and its control panel.

FIG. 17 is an end view of the armored vehicle of FIG. 14.

FIG. 18 is a partial cross-section view of the armored vehicle of FIG. 14.

FIG. 19 is another partial cross-section view.

FIG. 20 is an isometric view of a portion of a raisable table of the drone bay. An electric motor in communication with a gear raises and lowers the table as the gear travels along a gear rack. In truck-chassis embodiments, there can be one to three tables. In trailer-chassis embodiments, there can be as many as 24 tables in a single deck arrangement on up to 48 tables in a double deck arrangement.

FIG. 21A is a front elevation view of an embodiment of a multi-axle trailer that can be used in connection with a trailer-mounted embodiment of this disclosure.

FIG. 21B is a top plan view of the multi-axle trailer of FIG. 21A.

FIG. 22 is partial cutaway perspective view of an embodiment of this disclosure having multiple launch tables within its drone bays or trailer.

FIG. 23 is a perspective view of the embodiment of FIG. 22 as a launched drone exits the open roof section.

FIG. 24 is cutaway of shipping container adapted for use as a drone deployment system of this disclosure. The shipping container includes a slidable roof section, a launch platform below the slidable roof section, and can include a station for drone charging, maintenance and repair. The launch platform may be raised by a manual hoist and mechanical chain drive.

FIG. 25 is another embodiment of a shipping container of this disclosure including an electric hoist connected to the launch platform.

FIG. 26 is yet another embodiment of a shipping container of this disclosure including an electric chain drive to raise and lower the launch platform.

### ELEMENTS AND NUMBERING USED IN THE DRAWINGS AND DETAILED DESCRIPTION

10 Drone deployment system
20 Main bay or enclosed cargo bay
20b Bottom wall or floor
20d Drone bay within 20
20f Front wall
20r Rear wall
21 Side wall
21e Forward or rearward end of side wall
21f Fixed or stationary portion of side wall
21L Lower end of side wall
21m Midline of side wall
21u Upper end of side wall
23 Hinge
25 Pivotable or pivoting wall- or roof section
25b Bracing
25c Centerline
25h Horizontally oriented (top wall) portion of 25
25L Lower end or hinge end of section
25v Vertically oriented (side wall) portion of 25
27 Top wall or roof
27c Centerline
27e Forward or rearward end of top wall
27f Fixed or stationary portion of top wall
27s Left or right end of top wall
29 Joint
31 Seal
40 Cylinder
40c Longitudinal centerline of 40
41 Rod
41e Rod end
43 Curved bracket or arm
45 Proximal end of 43
47 Distal end of 43
49 Base end
50 3-bar hinge
51 First bar
53 Side wall end
55 Top wall end
57 Second bar
59 Side wall end
61 First bar end
63 Third bar
70 Launch platform
71 Launch table
73 Gear
75 Gear rack
79 Hoist (manual or electric)
79d Chain drive
80 Control room
81 Display
B Back of cab
D Drone
E End of frame
F Framing
FA Front axle
RA Rear axle
T Trailer
V Vehicle

### DETAILED DESCRIPTION

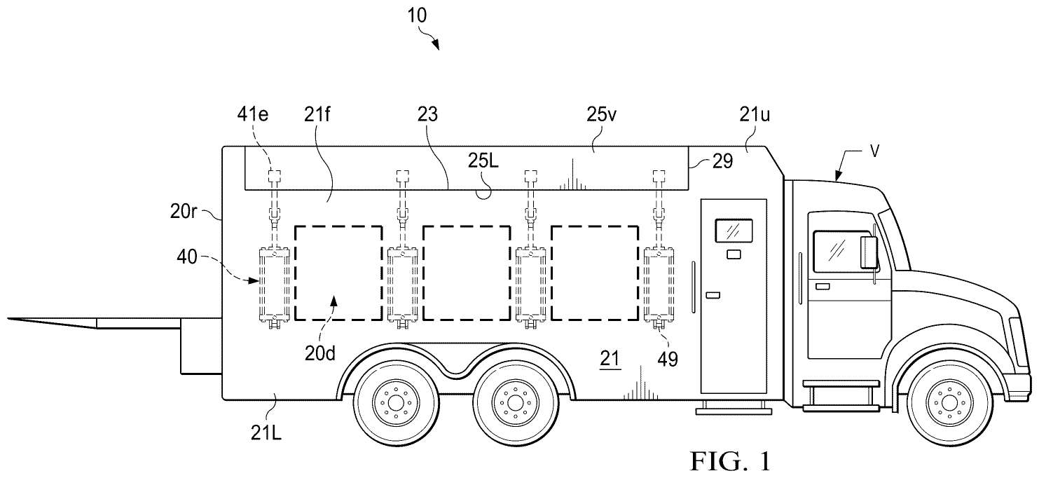

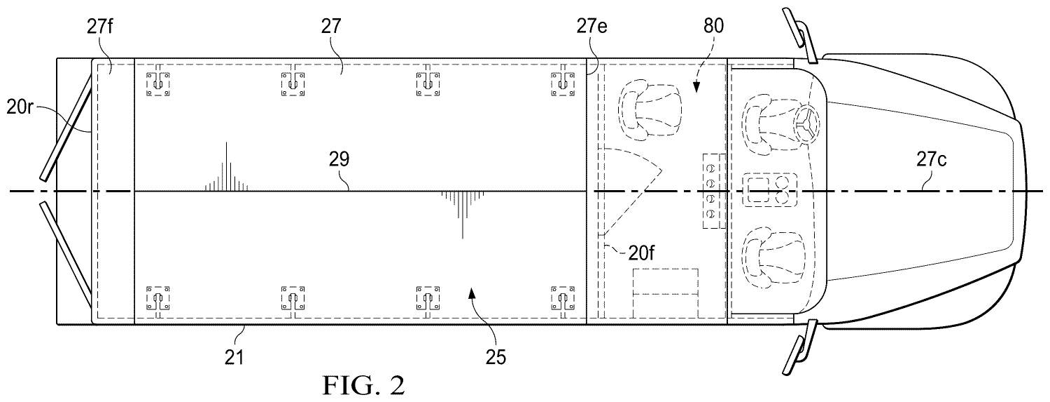

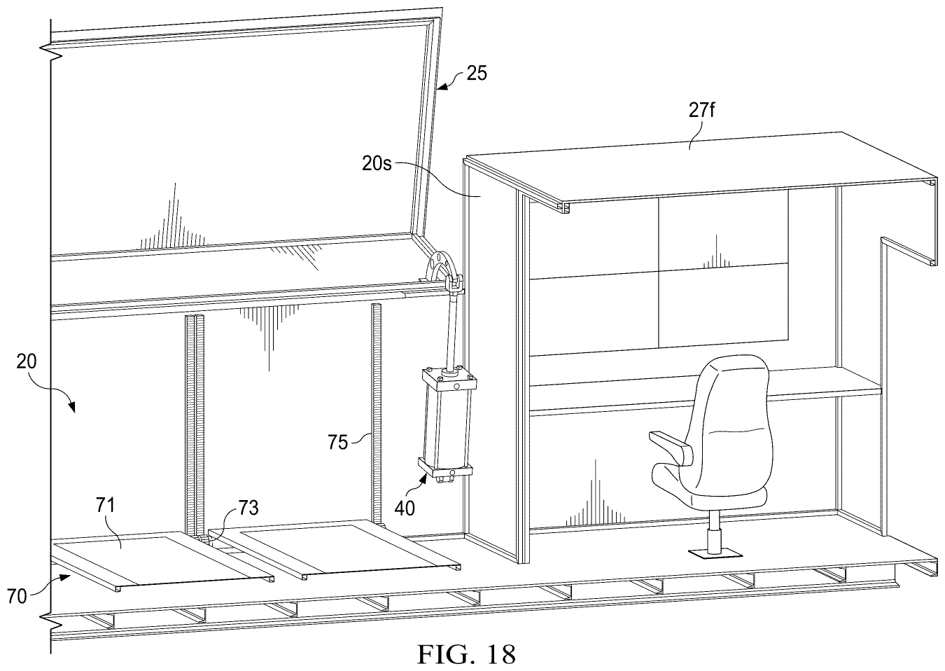

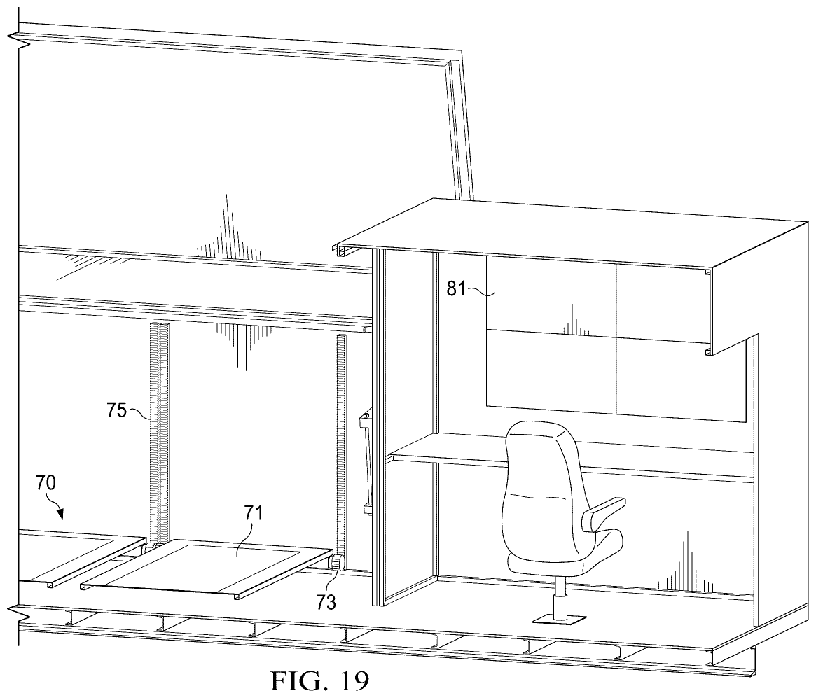

Referring to the drawings, and first to FIGS. 1, 2, 18, 19, 22, and 23 embodiments of a drone deployment system 10 of this disclosure comprise an enclosed bay or trailer 20 including at least one wall 21, 27 having a hinge 23 and a pivotable wall section 25 connected to the hinge 23; at least one hydraulic, pneumatic, electric cylinder 40 including a rod end 41 connected to the pivotable wall section 25; and a launch platform 70 housed within the enclosed cargo bay 20. In embodiments, the pivotable section 25 pivots or rotates about a longitudinally extending or horizontally oriented axis of rotation. The horizontal axis of rotation can be orthogonal to a front and rear wall 20f, 20r of the enclosed cargo bay 20.

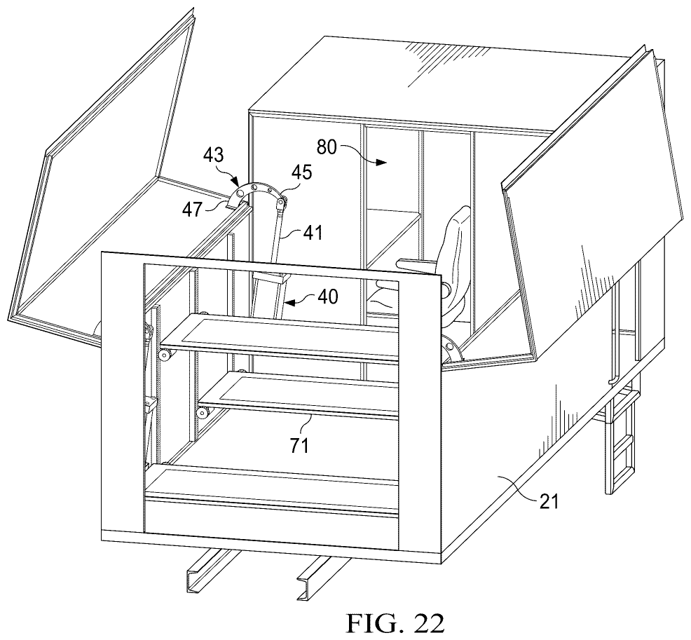

The launch platform 70 may include one or more launch tables 71. The launch tables 71 may be at a same or different elevation from one another, a same or different angular orientation, or a same or different elevations and angular orientation. See e.g., FIG. 22. The elevation and angular orientation of the launch platform 70 may differ from their stowed and deployed positions.

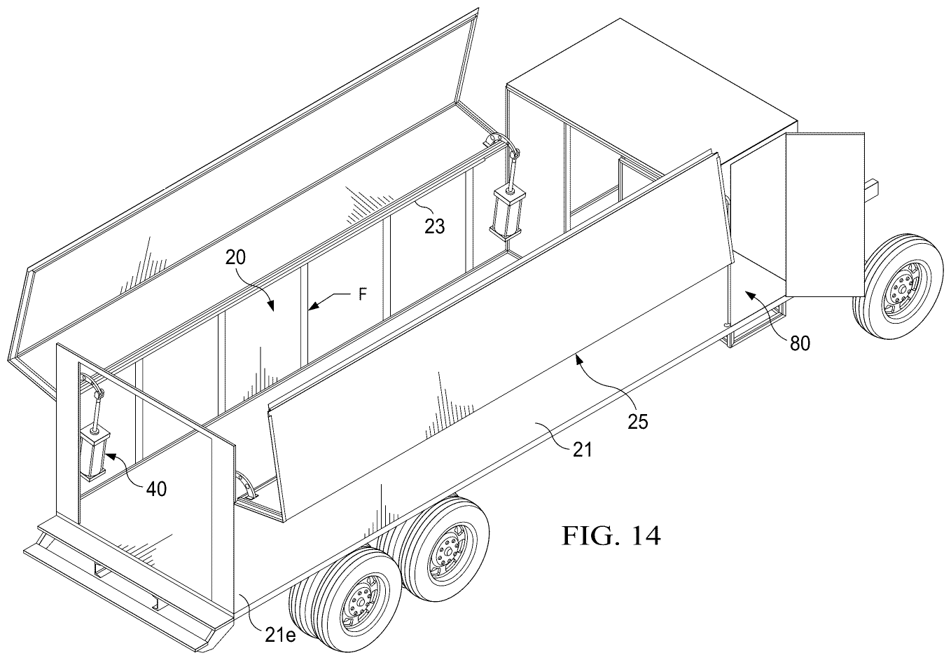

The enclosed cargo bay 20 may be mounted to a chassis of a motorized vehicle V. In some embodiments, the enclosed cargo bay 20 is part of an armored motorized vehicle V. In other embodiments, the enclosed cargo bay 20 is mounted to a trailer. See e.g., FIG. 14. Two or more enclosed cargo bays 20 may be arranged end-to-end. Two enclosed cargo bays 20 may also be arranged side to side to accommodate larger drones.

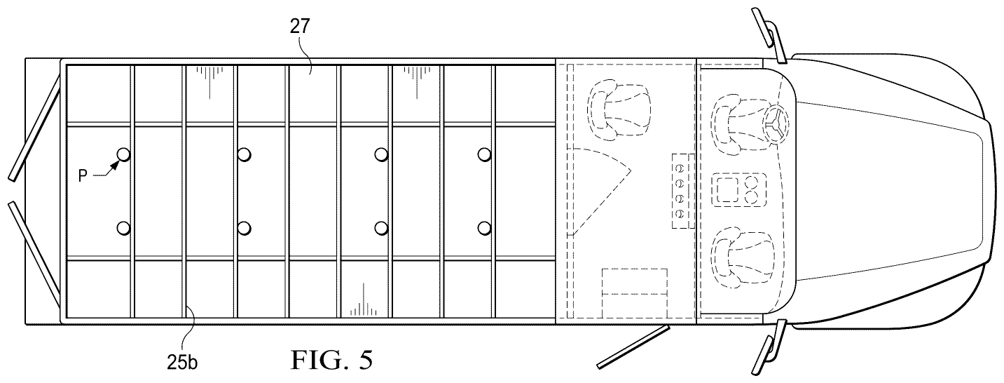

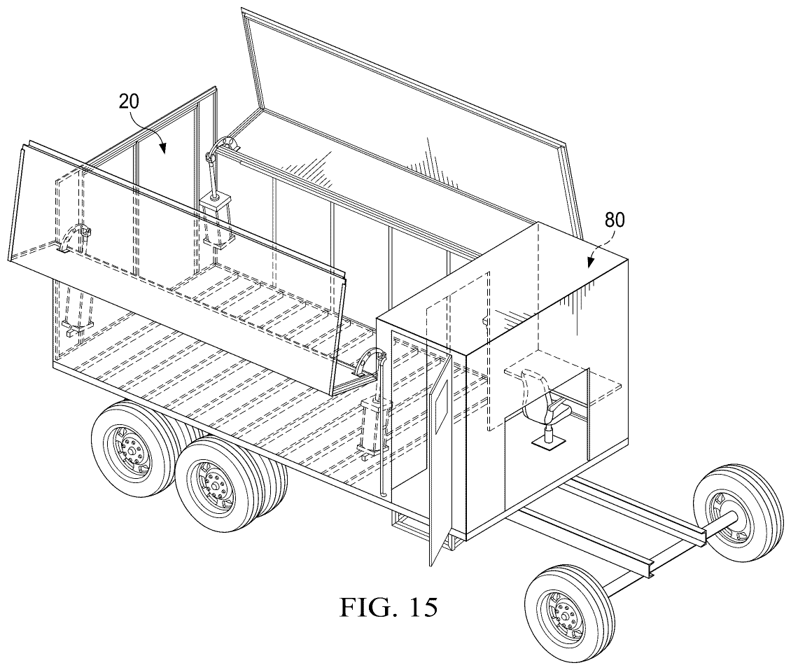

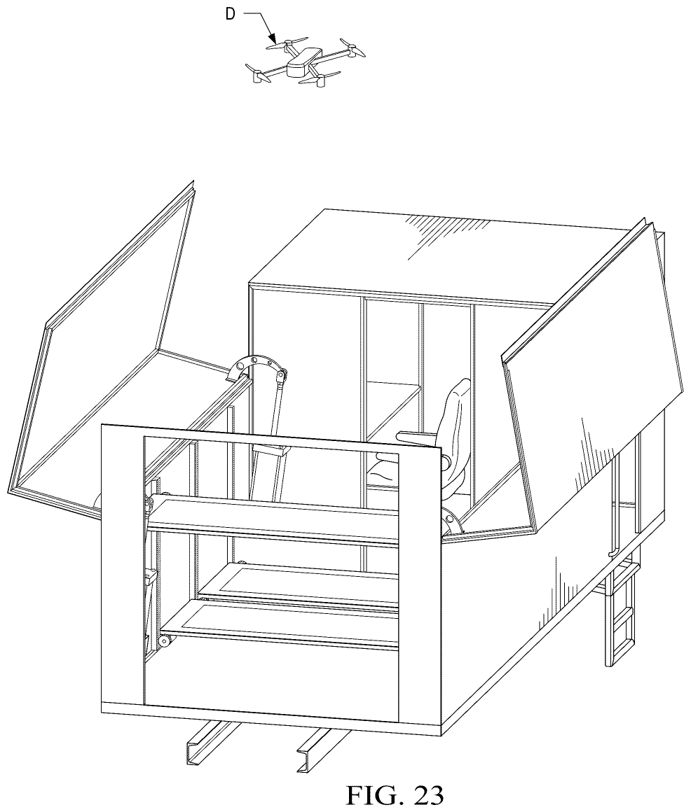

When the pivotable wall section 25 is in an opened or fully opened position, one or more drones D resting on the launch platform 70 may be deployed. See e.g., FIG. 23. The launch platform 70 may be adjustable in elevation or in angle (or both) and may be extendable in a horizontal direction. An operator control room 80 may be connected to the enclosed cargo bay 20 and used to control the cylinder 40, the launch platform 70, and the launching of one or more drones D. See e.g., FIGS. 5, 8, 15, and 19, 23.

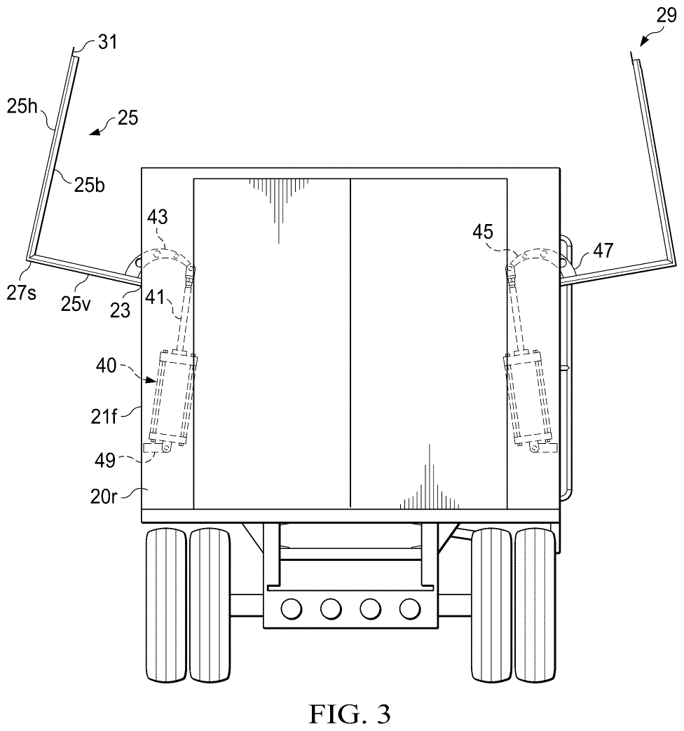

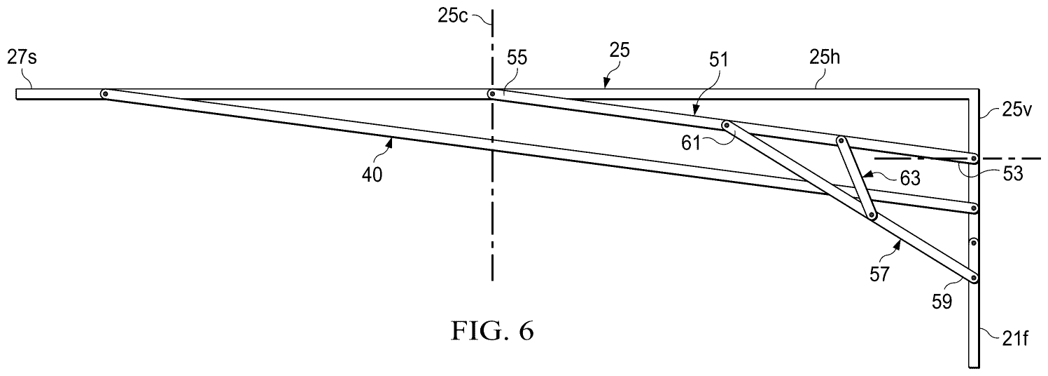

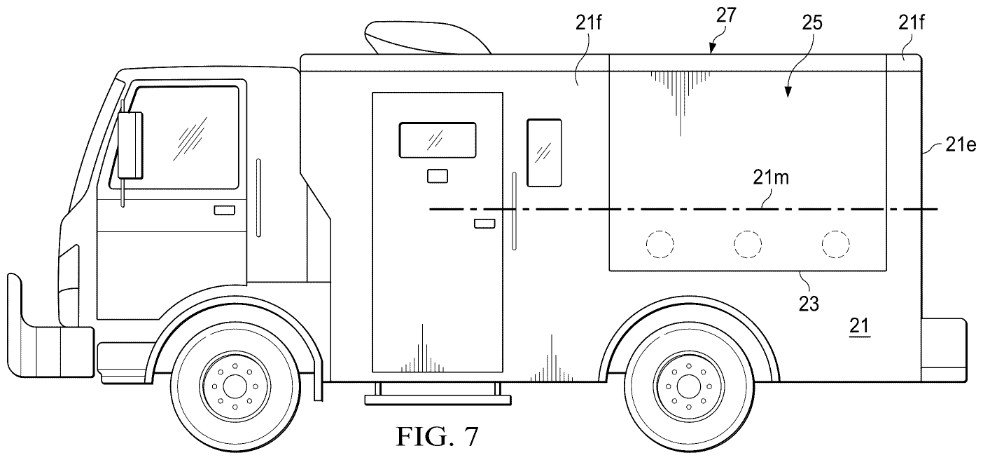

The at least one wall may be a side wall 21, the pivoting wall section 25 being all or a portion of the side wall 21. The pivotable wall section 25 may further include all or a portion of a top wall 27 adjacent to the side wall 21. See e.g., FIGS. 3 and 7. In some embodiments, at least one three-bar hinge 50 is connected to the side wall 21 and the portion of the top wall 27. See e.g., FIG. 6.

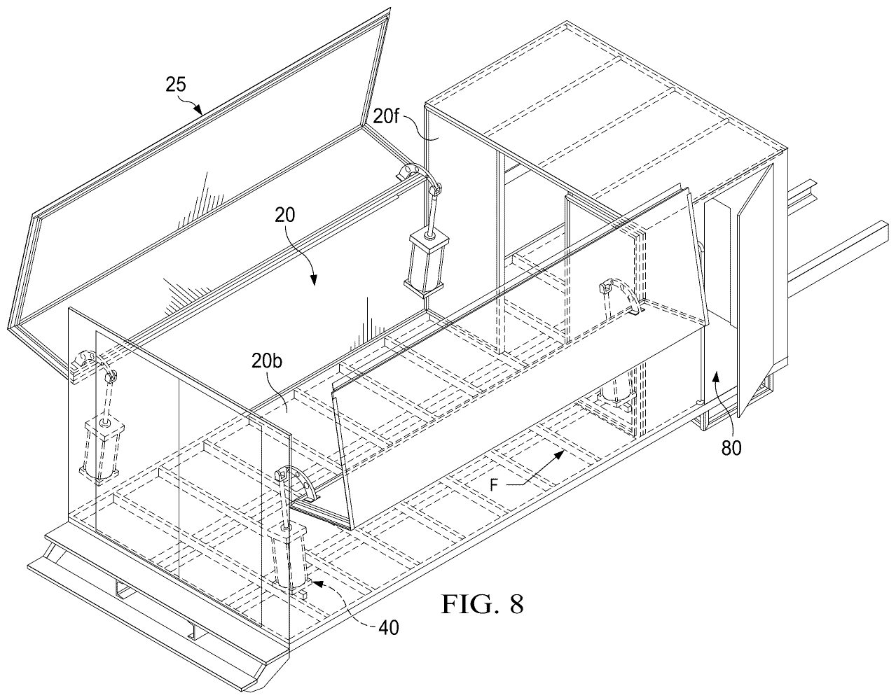

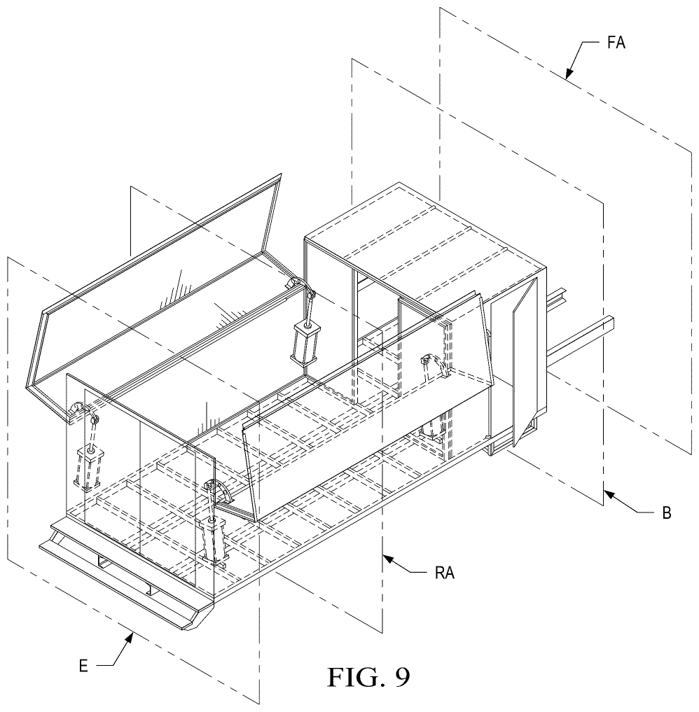

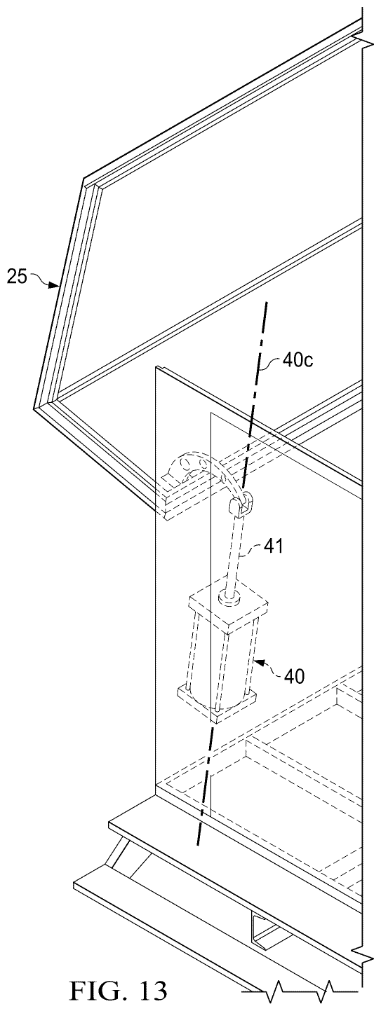

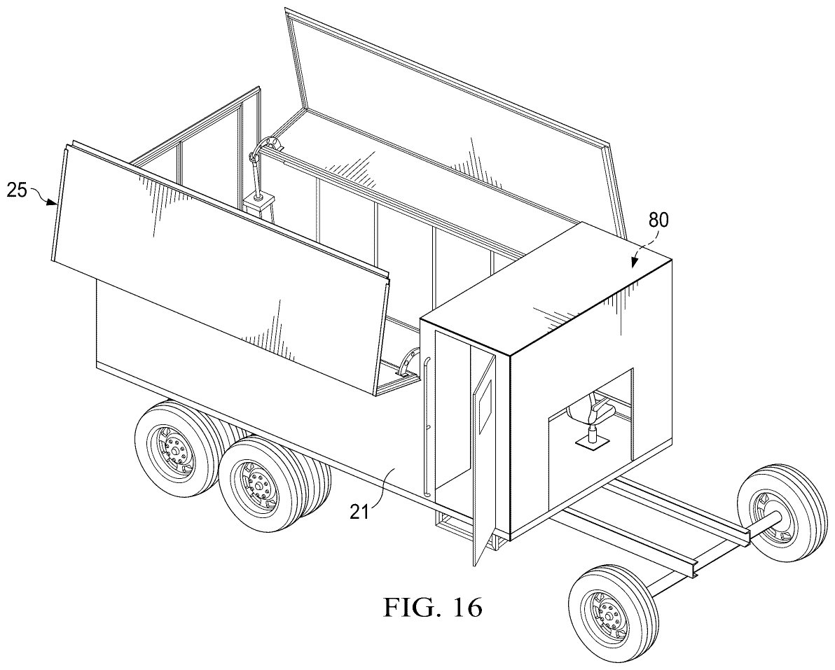

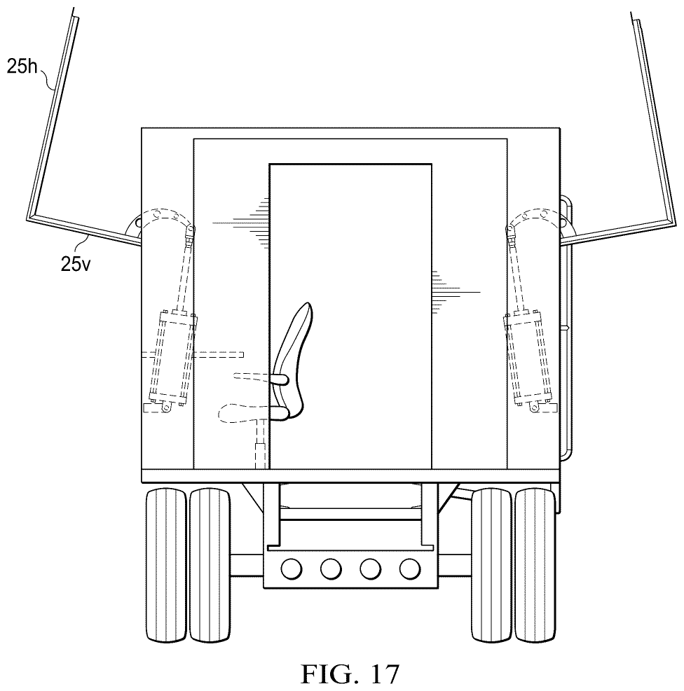

The at least one cylinder 40 may be mounted in a vertical or horizontal orientation. In some embodiments, pairs of cylinders 40 are used, with one cylinder 40 at or toward a corresponding end 25e of the pivotal wall section 25. The rod end 41 of the cylinder 40 may include a curved arm or curved bracket 43. The cylinder 40 may be oriented at an oblique angle to the side wall 21. See e.g., FIGS. 8, 9, 13 to 18, 22, and 23.

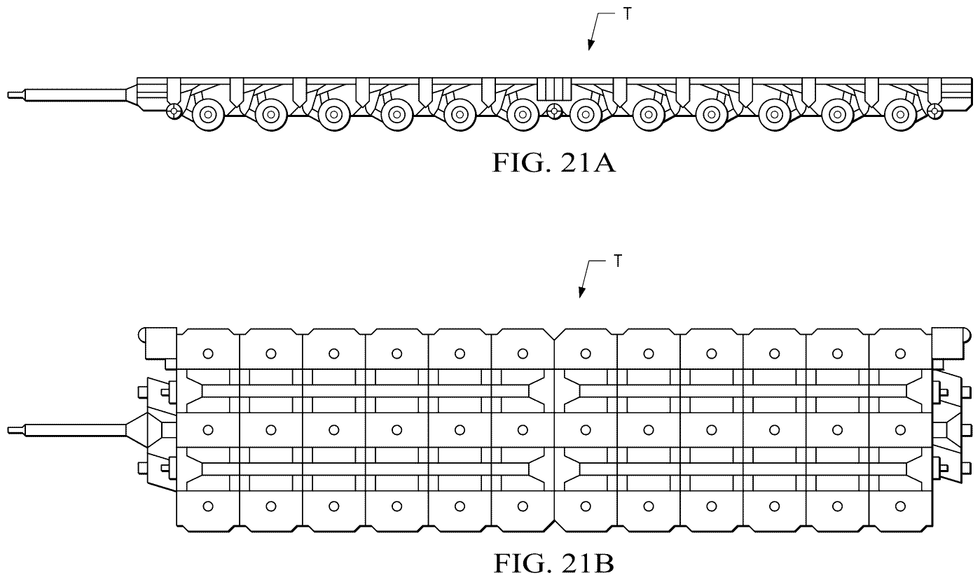

The enclosed cargo bay 20 may be in a range of about 20 feet to about 53 feet in length (˜6 m to ˜16 m) or greater, about 8 feet to about 17 feet wide (˜2.4 m to ˜5.2 m), and have an interior height of about 9 feet (˜2.7 m). In some embodiments, the enclosed cargo bay 20 is adapted for mounting to a trailer T. The trailer T may be a multi-axle trailer. See e.g., FIGS. 21A and 21B. In other embodiments, the enclosed cargo bay 20 may be a shipping container S. About, for the purposes of this disclosure, means within manufacturing tolerances generally accepted by those of skill in in the art.

In some embodiments of this disclosure, the top wall or roof 27 may be a retractable wall section 35 rather than a pivoting one. In this, as well as other embodiments, the launch table 71 may be raised and lowered by way of an electric motor, an electric chain drive, or a manual chain drive.

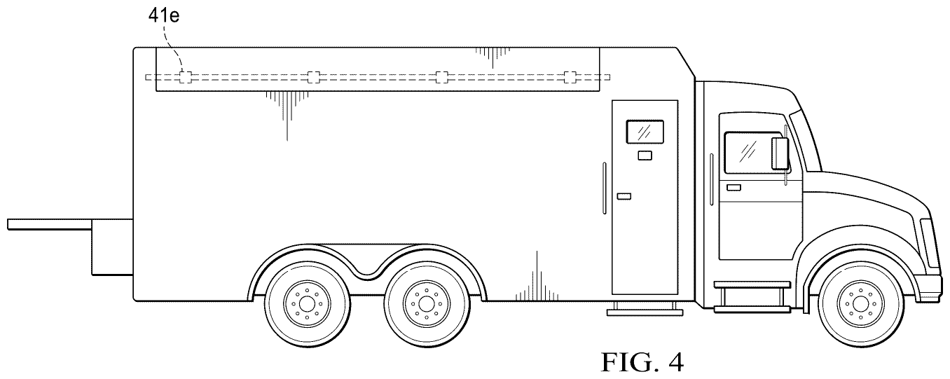

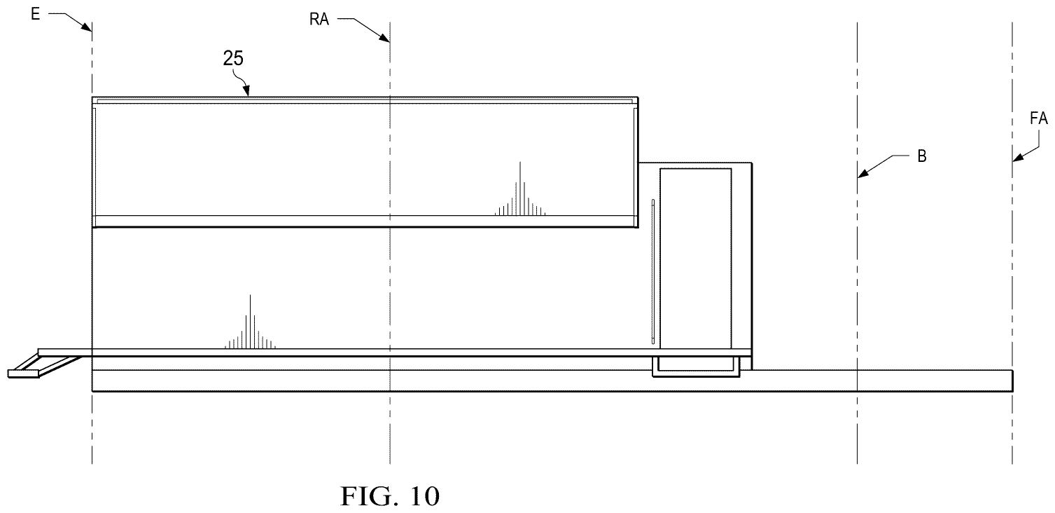

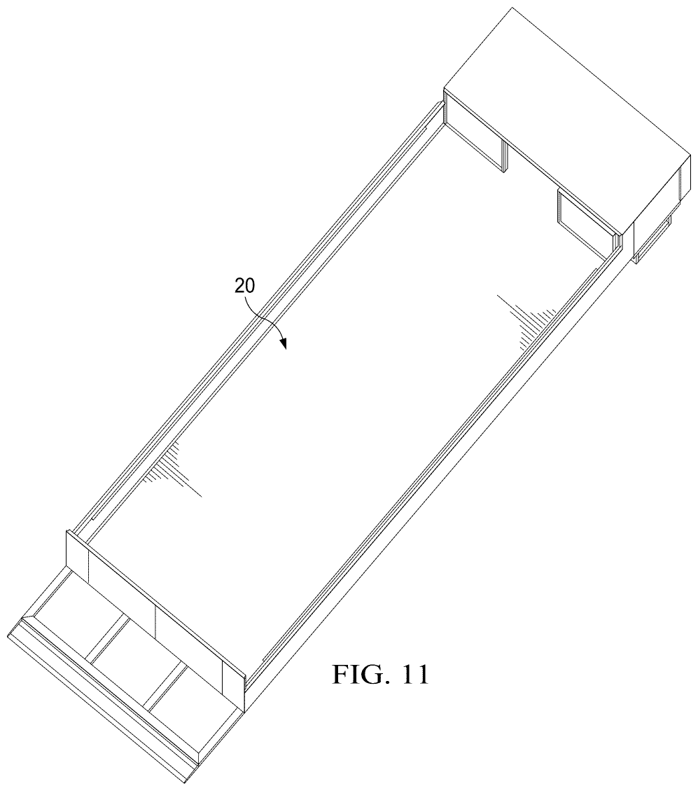

Referring now to FIGS. 1 to 23, in embodiments of a drone deployment system 10 of this disclosure, the main bay or enclosed cargo bay 20 of an armored vehicle V includes at least one drone bay 20d containing at least one drone (not shown) and its respective launching platform 70. The launch platform may be configured or arranged for horizontal take off, vertical takeoff, or angled takeoff. In some embodiments, the cargo bay 20 is configured to launch multiple ones of the same drone. In other embodiments, the cargo bay 20 is configured to launch two or more different drones and may include multiple drone bays 20d. By way of a non-limiting example, a first drone bay 20d may be configured to launch a first drone having a first capability and a second drone bay 20d may be configured to launch a second drone having a second capability different than the first.

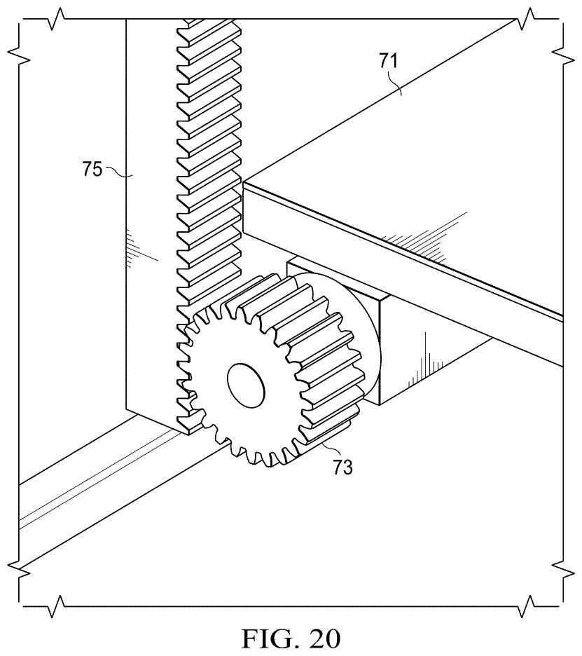

The launching platform 70 may include a drone table 71 that can be raised or lowered as the pivoting roof sections 25 are opening or closing. In some embodiments, the tables 71 are arranged along a single deck. In other embodiments, the tables 71 are in a double-deck arrangement. The tables 71 may be raised or lowered by an electric motor and included gearing 73 in communication with the electric motor. The gearing 73 travels along a vertically oriented gear rail 75 mounted to the side wall 21 of the vehicle V or its framing F. See e.g., FIG. 20.

In some embodiments, one pair of pivoting roof sections 25 are included. In other embodiments, two or more pairs of pivoting roof sections 25 are used, each roof section 25 corresponding to one of the drone bays 20d. The two or more pairs of roof sections 25 may be controlled independent of one another, as may the lifting platforms 70. A solid (non-pivoting, stationary) section 21f, 27f of wall 21, 27 may be adjacent each forward or rearward end 25e of the pivoting roof section 25. See e.g., FIGS. 1, 7 to 9, and 16.

In embodiments, the pivoting roof section 25 may pivot at least up to 90°, up to 120°, up 150°, or up to 180°, there being sub-ranges and discrete values within these broader ranges.

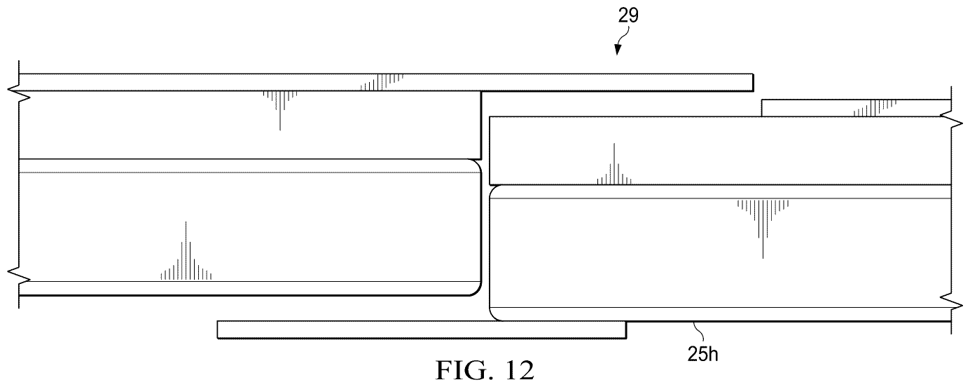

Each roof section 25 has a longitudinally extending hinge end 25L located along a side wall 21 of the vehicle V and a longitudinally extending joint end 25j located along the roof 27 of the vehicle V. The joint end 25j may include a seal 31. See. e.g., FIG. 12. In some embodiments, the seal 31 along the joint end 25j of one roof section 25 overlaps the seal 31 along the joint end 25j of another roof section 25. The forward and rearward ends 25e of each roof section 25 may also include a seal 31, as may the hinge end 25L along the side wall 21.

The roof sections 25 may be L-shaped, having a vertical (side wall 21) portion 25v extending along a respective first or second side wall 21 of the armored vehicle V. The side wall portion 25v of the roof section 25 extends to the hinge 23. The hinge 23 may be located along the side wall 21 of the vehicle V at any desired height. In some embodiments, the hinge 23 is located nearer the roofline of the armored vehicle V than it is to the mid-line. The hinge 23 may be located in a range of about 1 foot to 2 feet (˜0.3 m to ˜0.6 m) below the upper end 21u of the vehicle side wall 21. In other embodiments, the hinge 23 is located nearer the mid-line 21m of the side wall 21. In yet other embodiments, the hinge 23 is located nearer the wheel well. The hinge 23 may be located just above the wheel well or within a foot (˜0.3 m) of the wheel well. The location of the hinge 23 may be predetermined based upon the size and type of drone to be launched, including but not limited to the orientation of the launching platform 70.

Each roof section 25 includes ribs or bracing 25b along its interior side to provide rigidity and strength. One or more cylinders 40 are located below the bracing 25b, with the rod and base ends 41, 49 of the cylinder 40 each connected to a respective, corresponding portion of the bracing 25b. See e.g., FIG. 3. Each cylinder 40 may be oriented such that its rod (extendable) end 41e connects to the side wall portion 21v of the roof section 25 and its base (fixed) end 49 connects to or toward the longitudinally extending joint end 29 of the roof section 25. In embodiments, the rod end 41e connects adjacent the hinge end 25L. The cylinders 40 may be hydraulic, pneumatic, or electric, the fluid or power source being plumbed to the vehicle in ways known in the art. Controls of a kind known in the art may be used to actuate and retract the cylinders 40.

In embodiments, the cylinders 40 may be pneumatic cylinders in communication with a supercharger and a air tank. By way of a non-limiting example, the air tank may be a 250 gallon air tank. The air lines to the cylinders 40 may be arranged along the side wall 21 of the vehicle V.

In some embodiments, each cylinder 40 is paired with a 3-bar hinge 50 that limits the overall travel of the roof section 25. See FIG. 6. A first bar 51 of the 3-bar hinge 50 may be connected to the roof section 25 centerline to centerline. A second bar 57 of the 3-bar hinge 50 has one end 59 connected to the side wall 21 of the vehicle V and another end 61 connected to the first bar 51. The one end 61 connected to the side wall 21 may be at or near the same elevation as the hinge 23. In some embodiments, the one end 61 is connected to the hinge 23. A third bar 63 extends between the first and second bars 51, 57.

In some embodiments of this disclosure, an armored vehicle V includes a pair of longitudinally extending roof sections 25 arranged opposite one another, each longitudinally extending roof section 25 including bracing 25b along an underside, each longitudinally extending roof section 25 having a horizontal portion 25h and a vertical portion 25v; a longitudinally extending hinge 23 located along a sidewall 21 of the armored vehicle, the vertical portion 25v of the roof section 25 connected to the longitudinally extending hinge 23; and at least one cylinder 40 located below the bracing 25b, the at least one cylinder 40 having a one end 41e, 49 connected to the horizontal portion 25h between a longitudinal edge 25s and a longitudinal centerline 25c of the horizontal portion 25h and another end 49, 41e connected to the vertical portion 25v between a lowermost longitudinal edge 21L and a longitudinal centerline 25c of the vertical portion 25v, the at least one cylinder 40 moveable between a fully retracted and fully extended position; at least one 3-bar hinge 50 located adjacent the at least one cylinder 40, a first bar 51 of the 3-bar hinge having one end 55 connected to the horizontal portion 25h at its longitudinal centerline 25c and another end 53 connected to the vertical portion 25v at its longitudinal centerline 25c, a second bar 57 of the 3-bar hinge 50 having one end 57 connected to a side wall 21 of the armored vehicle V; wherein when the at least one cylinder 40 moves to a fully extended position, a corresponding one of the longitudinally extending roof sections 25 pivots about the longitudinally extending hinge 23.

In other embodiments of this disclosure, the armored vehicle V includes an arcuate or curved bracket 43 connected at one end 45 to the cylinder rod 41 and at another end 47 to the longitudinally extending roof section 25, toward the lowermost end 25L of the vertical portion 25 of the roof section 25. See e.g., FIGS. 3, 8, 9, 13 to 19, 22 and 23. One cylinder 40, rod 41, and curved bracket 43 may be located toward each forward and rearward end 25e of the pivoting roof section 25. The cylinder 40 and rod 41 are arranged so that the rod 41 runs at an oblique angle relative to, and away from, the side wall 21, thereby permitting the curved bracket 43 to clear the longitudinally extending hinge 23 as the roof section 25 pivots. The curve of the bracket 43 extends through an arc effective for the bracket 43 to clear the hinge 23 as the roof section 25 pivots and to then hold the now-pivoted roof section 25 at a desired fully open position or partially open position. By way of a non-limiting example, the curve may extend through 900 upwards to 180°.

In embodiments of this disclosure, an armored vehicle V includes a pair of longitudinally extending roof sections 25 arranged opposite one another, each longitudinally extending roof section 25 including bracing 25b along an underside, each longitudinally extending roof section 25 having a horizontal portion 25h and a vertical portion 25v; a longitudinally extending hinge 23 located along a side wall 21 of the armored vehicle V, a lowermost longitudinal edge 25L of the vertical portion 25v of the roof section 25 connected to the longitudinally extending hinge 23; a curved bracket 43 having one end 47 connected to the vertical portion 25v of the roof section 25 toward the lowermost longitudinal edge 25L of the vertical portion 25v; at least one cylinder 40 located below the longitudinally extending hinge 23, the cylinder 40 including a rod 41 having one end 41e connected to another end 45 of the curved bracket 43, the at least one cylinder 40 moveable between a fully retracted and fully extended position; wherein when the at least one cylinder 40 moves to a fully extended position, a corresponding one of the longitudinally extending roof sections 25 pivots about the longitudinally extending hinge 23.

In embodiments of this disclosure, the enclosed cargo bay 20 may be mounted on a truck chassis of an armored vehicle V. By way of a non-limiting example, the armored vehicle V may be an OSHKOSH® MTVR MK27 vehicle or its equivalent. In other embodiment, enclosed cargo bay 20 may be mounted on a trailer T. The trailer T may be a multi-axle trailer and include an operator cab having controls in communication with the drone bay 20d. The trailer T may be a flat bed trailer or a step deck trailer. In some embodiments, the trailer T is a GOLDHOFER® multi-axle trailer. See e.g., FIGS. 21A and 21B.

The armored vehicle V with enclosed cargo bay 20 includes a launching platform 70 for drones, including at least one table 71 that may be raised and lowered as the pivoting roof sections 25 open and close. In embodiments in which the enclosed bay 20 is sized for mounting on a truck chassis of an armored vehicle V, the launching platform 70 may include up to three tables 71 or more. In embodiments in which the enclosed cargo bay 20 is sized for mounting on a trailer T, the launching platform 70 may include up to 24 tables 70 in a single deck arrangement and on up to 48 tables 70 in a double deck arrangement.

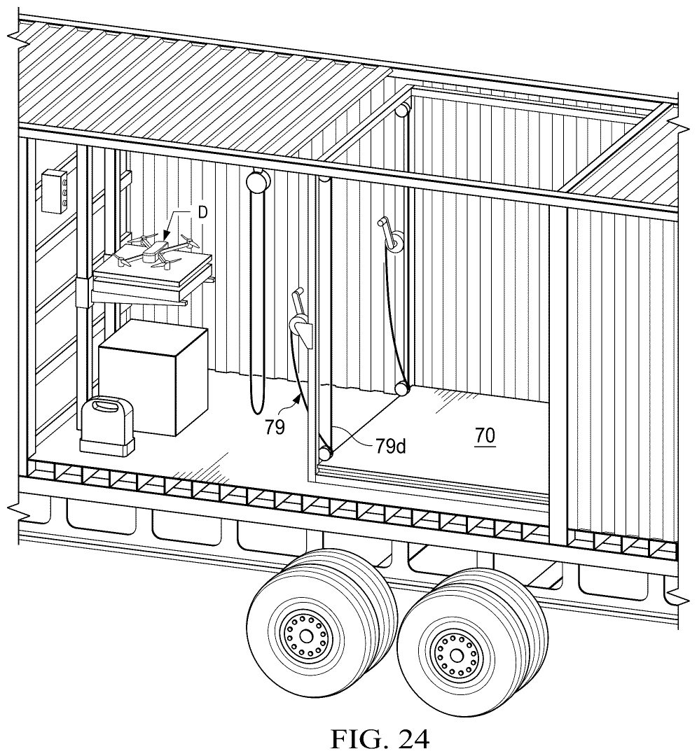

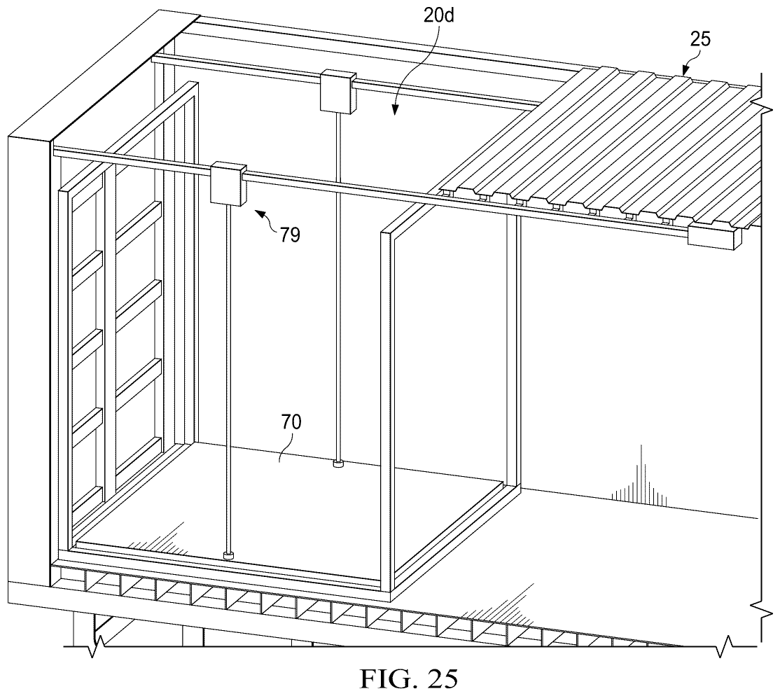

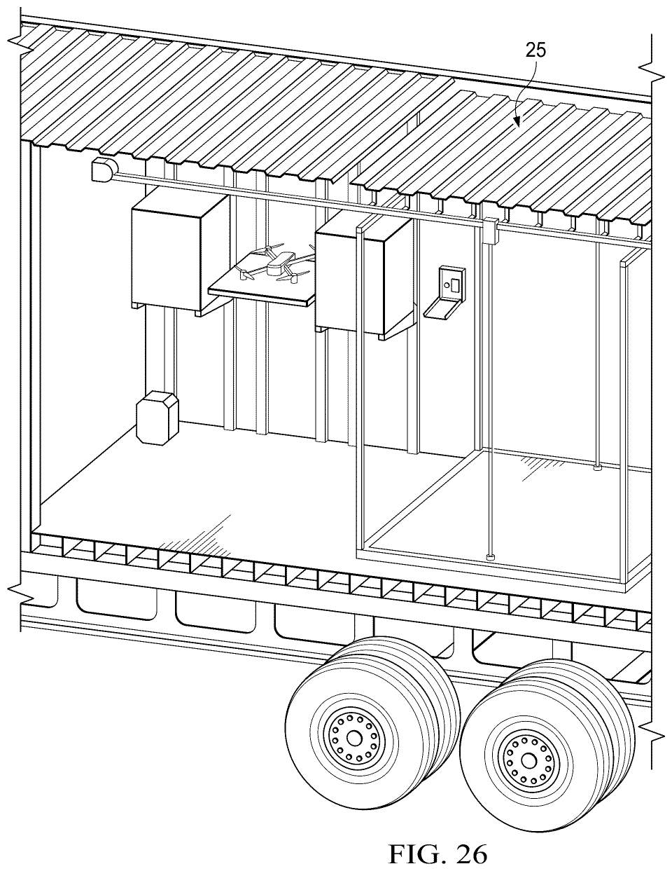

In yet other embodiments of this disclosure, the enclosed cargo bay 20 may be a shipping container S adapted for use as a drone deployment system 10. See e.g., FIGS. 24 to 26. The shipping container S may include a pivoting roof section 25, the same or similar to that previously described, or a retractable (non-pivoting) roof section 35. When in the open position, the retractable roof section 35 and a fixed or stationary portion of the top wall 27f may overlap one another. The shipping container S may also be armored. Two or more shipping containers S may be connected end-to-end.

One or more launch platforms 70 or tables 71 may be located within a single drone bay 20d or in the trailer 20. In embodiments, the launch platform 70 may be raised by a manual crane or hoist 79 and mechanical chain drive 79d. In other embodiments, the launch platform 70 may be raised by an electric crane or hoist 79 connected to the launch platform 70. In yet other embodiments, the launch platform 70 may be raised by electric chain drive 79d to raise the launch platform 70. Similar lifting arrangements may be adapted for use in the previously described armored vehicle V and trailer T embodiments of this disclosure.

While embodiments of drone deployment system of this disclosure have been described, modifications may be made in the details of its construction without departing from the scope of the following claims, the recited elements of which are entitled to their full range of equivalents.

1. A drone deployment system comprising:
an enclosed cargo bay including at least one wall having at least one section moveable between a closed position and an opened position; and
a launch platform adapted for use with one or more drones, the launch platform housed by the enclosed cargo bay and located opposite the at least one section, the launch platform moveable between a stowed and a deployed elevation, angular orientation, or elevation and angular orientation.

2. The drone deployment system of claim 1, wherein the at least one wall is a top wall including a fixed section adjacent to the at least one section, the at least one section is slidable in a longitudinal direction of the enclosed cargo space between the closed and opened positions, the fixed section and the at least one section overlapping one another at least partially when the at least one section is in the opened position.

3. The drone deployment system of claim 1, wherein the at least one section is pivotable, about an axis extending in a longitudinal direction of the enclosed cargo space, between the closed and opened positions.

4. The drone deployment system of claim 3, further comprising the at least one wall including a hinge, the at least one section connected to the hinge.

5. The drone deployment system of claim 4, wherein the at least one wall is a side wall, the hinge located toward a lower end of the side wall.

6. The drone deployment system of claim 4, the at least one section having a seal at an end opposite that connected to the hinge.

7. The drone deployment system of claim 4, further comprising:
at least one cylinder including a rod end connected to the at least one section, the at least one cylinder chosen from a hydraulic, pneumatic, or electric cylinder.

8. The drone deployment system of claim 3, wherein the at least one section further includes a portion of another wall arranged orthogonal to the at least one wall.

9. The drone deployment system of claim 8, wherein the at least one wall is a side wall and the another wall is a top wall.

10. The drone deployment system of claim 9, further comprising at least one three-bar hinge connected to the side wall and the top wall.

11. The drone deployment system of claim 7, further comprising a curved arm having one end connected to the rod end of the at least one cylinder and another end connected to the at least one section.

12. The drone deployment system of claim 7, wherein the at least one cylinder is oriented at an oblique angle to the at least one wall.

13. The drone deployment system of claim 7, wherein the at least one cylinder is in a vertical orientation.

14. The drone deployment system of claim 7, wherein the at least one cylinder is in a horizontal orientation.

15. The drone deployment system of claim 1, wherein the at least one wall includes a fixed section adjacent to the at least one section.

16. The drone deployment system of claim 1, wherein the launch platform comprises one or more launch tables.

17. The drone deployment system of claim 1, wherein the launch platform is extendable in a horizontal direction.

18. The drone deployment system of claim 1, further comprising an operator control room connected to the enclosed cargo bay, the operator control room including controls in communication with the at least one section and the launch platform.

19. The drone deployment system of claim 1, wherein the enclosed cargo bay is adapted for connection at least one of a vehicle frame and a trailer.
